(19) United States
(12) Patent Application Publication
(10) Pub. No.: US 2010/0295213 A1
(43) Pub. Date: Nov. 25, 2010

(54) PROCESS FOR EMBOSSING WEB MATERIALS

(76) Inventor: Kevin Benson McNeil, Loveland, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/722,747

(22) Filed: Mar. 12, 2010

Related U.S. Application Data
(63) Continuation of application No. 12/469,720, filed on May 21, 2009.

(51) Int. Cl. B29C 59/04

(52) U.S. Cl. 264/284

(57) ABSTRACT

A process for embossing a web substrate is disclosed. The process comprises the steps of: 1. disposing the web substrate in a circumferentially elongate nip formed between a pattern roll having a circumference and an embossing pattern disposed upon a surface thereof and a continuous belt disposed about at least a portion of the circumference of the pattern roll; 2. providing the continuous belt with a surface speed corresponding to a speed of the web substrate; and, 3. juxtaposing the embossing pattern upon the web substrate while the web substrate is disposed within the elongate nip.

### PRIORITY

This application is a continuation of, and claims priority to, U.S. patent application Ser. No. 12/469,720 filed May 21, 2009.

### FIELD OF THE INVENTION

The present invention relates to embossing a web substrate and particularly to decorative embossing a single ply, or multiple plies, of bath tissue or paper toweling.

### BACKGROUND OF THE INVENTION

Embossing and embossing technology is well known in the prior art. Embossing is a common technique used for a plurality of reasons. In a first instance, embossing is a common technique used to join two plies of paper together in order to form a multi-ply laminate. The resulting laminate has properties such as caliper, flexibility, and absorbency not attainable from a single ply having twice the basis weight of either constituent ply. In this regard, embossing can be accomplished by one of several known embossing processes such as knob-to-knob embossing or dual-ply lamination. Such processes are disclosed in U.S. Pat. Nos. 3,414,459 and 5,294,475. Yet another embossing process for joining two plies together is called nested embossing and is well known in the art.

Also known is the embossing of a single-ply product in order to provide a decorative appeal to the final embossed product. The embossment of a single-ply paper product can make the resulting product more absorbent, softer, and bulkier over a comparative unembossed product. The embossing of single-ply products can be accomplished by the use of pin-to-pin embossing where protrusions on the respective embossing rolls are matched so that the tops of the corresponding protrusions contact each other through the paper product. This process results in the compression of the fibrous structure of the product. Similarly, embossing single-ply products can be accomplished by the use of male/female embossing (also called nested embossing) where the protrusions of one or both rolls are aligned with each a non-protrusion area or a female recession in the other rolls. Such processes are shown in U.S. Pat. No. 4,921,034.

With each of the foregoing embossing processes, embossments are deflected out of the plane of the paper. Such deflection may desirably increase the caliper of that ply. For example, conventional embossing may increase caliper 25 to 135% as the emboss pressures deform the fibers out of the plane of the paper.

By embossing out of the plane of the paper, it is meant that the embossments extend outwardly from the original thickness of the unembossed paper product. Thus, embossments which are deformed out of the plane of the paper extend outwardly from the surface of the paper, thereby increasing its caliper. The aesthetic clarity of the embossed pattern is directly proportional to the magnitude of the out-of-plane deformation of these embossments.

Typical prior art embossing processes can rely upon a conventional rubber anvil roll and a steel pattern roll to form the aesthetic pattern. This type of embossing is known to those of skill in the art as knob-to-rubber embossing (also known as rubber-to-steel). In knob-to-rubber embossing, a hard embossing roll having emboss protrusions or emboss knobs disposed in a desired pattern thereon mates with the surface of a soft impression roll. As a paper web is passed through the nip formed between these rolls, the emboss knobs impress the web against and into a soft impression roll to deform the overall structure and resulting appearance of the web. In other words, the aesthetic pattern results from the deformation of the fibers out of the plane of the paper when the plies are embossed against the deformable anvil roll. Such a process and apparatus are shown in U.S. Pat. No. 5,436,057.

The conventional wisdom by users of such rubber-to-steel techniques provides for the use of a relatively large soft rubber roll in conjunction with the steel pattern roll. Without desiring to be bound by theory, the large soft rubber roll deforms significantly under the pressures developed and necessary to emboss a paper substrate. This deformation of the large soft rubber roll provides for nip widths that are significantly greater than a mere tangential relationship of the lightly contacting rolls forming the rubber-to-steel system. By providing for a large nip width, the paper product being deformed therein is provided with a longer duration in between the two rolls and undergoes significant product deformation to provide a product having relatively deep embossments. These embossments have been found to be highly desirable to consumers.

However, it is also known to these practitioners that there is an associated loss in tensile strength caused by these out-of-plane embossments. It is not uncommon for certain substrates to suffer a 20 to 40% tensile loss during such conventional embossing processes. Additionally, such systems have been found to degrade the apparent softness of the resulting structure. This softness degradation has been attributed to the tactile sensation caused by these out-of-plane embossments.

In light of these defects in the known prior art, it was surprisingly found that providing a high level of between the embossment and the unembossed paper structure surrounding the embossment can communicate depth and effective embossing to these consumers. Even more surprising, it was found that this benefit can be provided at a significantly higher line speed if the roll is not provided as a relatively soft rubber roll but rather as a roll having a hard surface.

### SUMMARY OF THE INVENTION

The present invention provides an exemplary process for embossing a web substrate. The process comprising the steps of: 1. disposing the web substrate in a circumferentially elongate nip formed between a pattern roll having a circumference and an embossing pattern disposed upon a surface thereof and a continuous belt disposed about at least a portion of the circumference of the pattern roll; 2. providing the continuous belt with a surface speed corresponding to a speed of the web substrate; and, 3. juxtaposing the embossing pattern upon the web substrate while the web substrate is disposed within the elongate nip.

Another exemplary process provides a process for embossing a web substrate. The process comprising the steps of 1. disposing the web substrate in a circumferentially elongate nip formed between a pattern roll having a circumference and an embossing pattern disposed upon a surface thereof and a continuous belt disposed about at least a portion of the circumference of the pattern roll; 2. providing the continuous belt with a surface speed corresponding to a speed of the web substrate; 3. adjusting the surface of the pattern roll relative to the continuous belt to provide a compressive force on the surface of the pattern roll; and, 4. juxtaposing the embossing pattern upon the web substrate while the web substrate is disposed within the elongate nip.

Yet another exemplary process provides a process for embossing a web substrate. The process comprising the steps of: 1. disposing said web substrate in a circumferentially elongate nip formed between a pattern roll having a circumference and an embossing pattern disposed upon a surface thereof and a continuous belt disposed about at least a portion of said circumference of said pattern roll; 2. providing said continuous belt with a surface speed corresponding to a speed of said web substrate; 3. adjusting said continuous belt relative to said surface of said pattern roll to provide a desired distance between said continuous belt and said surface of said pattern roll; and, 4. juxtaposing said embossing pattern upon said web substrate while said web substrate is disposed within said elongate nip.

### BRIEF DESCRIPTION OF THE DRAWINGS

FIG. 1 is a schematic side elevational view of an apparatus for embossing paper according to the present invention.

FIG. 1A is an enlarged view of the region labeled 1A of FIG. 1;

FIG. 2 is a schematic side elevational view of an alternative embodiment for embossing paper;

FIG. 3 is a schematic side elevational view of yet another alternative embodiment for embossing paper; and,

FIG. 4 is a schematic side elevational view of still another alternative embodiment for embossing paper.

### DETAILED DESCRIPTION OF THE INVENTION

The instant invention can be neatly parsed into three easily recognizable portions. These are: 1) the apparatus for producing an embossed substrate; 2) the process for making an embossed substrate; and 3) the unique embossed substrate produced by the described apparatus. The description of each section of the claimed apparatus is described forthwith.

### Apparatus

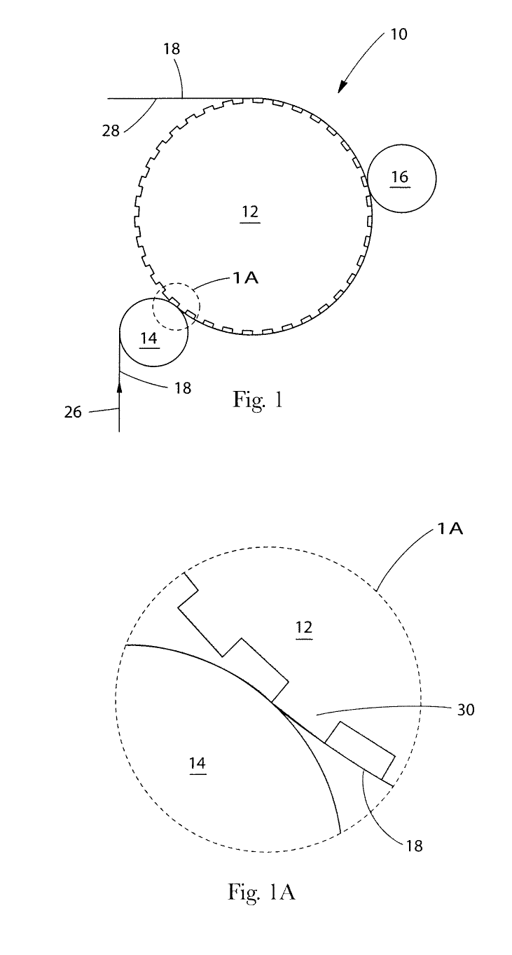

Referring to FIGS. 1 and 1A, the embossing apparatus of the present invention can be provided with at least two cylindrical axially parallel rolls juxtaposed to form a nip therebetween. The first roll is a pattern roll 12 that has protuberances 30 extending radially outward from the periphery of the roll 12. The second roll is an anvil roll 14 and has a surface which is generally smooth to the naked eye. Preferably, the anvil roll 14 has a machined surface with a finish of 32 micro inches or less.

The pattern roll 12 can comprise any combination of ‘line’ emboss elements and ‘dot’ emboss elements. A line emboss element can be characterized by having a depth relative to the surface of the respective surface of a web material. A line emboss element can also characterized by having a total embossment length to total embossment width (or an aspect ratio) of greater than 1. A dot emboss element can be characterized by having a depth relative to the surface of the web material. A dot emboss element can also be characterized by having a total embossment length to total embossment width (or an aspect ratio) of 1.

In a preferred embodiment, neither the pattern roll 12 nor the anvil roll 14 deform during the embossing process. However, while some theoretical deformation in response to an applied load may be predicted, the pattern roll 12 and the anvil roll 14 are sufficiently non-deformable and rigid to obviate deformation which permits out-of-plane embossments to be formed in the paper web 18. In one embodiment, the anvil roll 14 may be a crowned roll. In a preferred embodiment, deflection of the pattern roll 12 and anvil roll 14 is minimized and controlled in a predictable manner.

Each of the pattern rolls 12 and anvil rolls 14 is preferably formed from steel and more preferably hardened, although any relatively non-deformable rigid material may be used. It is preferred that the anvil roll 14 not be provided with a softer rubber cover. In stark contrast, a very hard roll, such as an anvil roll 14 having a cover with a hardness of less than about 40 P&J, more preferably less than about 30 P&J, even more preferably less than about 20 P&J, and yet more preferably less than about 10 P&J as measured with a ⅛-inch diameter ball under a constant load of one kilogram at a temperature of 70° F. after sixty seconds, is best suited for the instant application. By way of non-limiting example, it was found suitable that the pattern roll 12 is provided with a 14-inch diameter and the corresponding anvil roll 14 is provided with a 7-inch diameter.

Preferably, the pattern roll 12 is stationary, and the anvil roll 14 is loaded although, if desired, the opposite arrangement could be used. Alternatively, each of the pattern roll 12 and anvil roll 14 could be pneumatically, hydraulically, or linear actuator loaded and biased towards the other pattern 12 or anvil roll 14. Load cells may be incorporated into the mounting of each of the pattern roll 12 and anvil roll 14 to equalize loading across the nip to allow for monitoring pressure fluctuations during embossing.

Alternatively, the pattern roll 12 and the anvil roll 14 are diametrically loaded together along the plane connecting the centers of the pattern roll 12 and anvil roll 14. The pattern roll 12 and anvil roll 14 may be loaded together by pneumatic, or preferably hydraulic, loading cylinders, or more preferably by linear actuators. Preferably, there is one loading cylinder at each end of the pattern roll 12 and anvil roll 14 to be pneumatically, or more preferably hydraulically or via linear actuator loaded. However, one of skill in the art will understand that engagement between the pattern roll 12 and anvil roll 14 may be controlled by pneumatic loading cylinders, hydraulic loading cylinders, rotation of a ball/screw mechanism in a linear actuator, or any other suitable means, to load both ends of the anvil roll 14 against both ends of the pattern roll 12 with a desired first force or to a desired first amount of engagement.

An exemplary, but non-limiting, embossing process of the present invention may comprise any form of dual or multi-nip configurations. These processes may comprise unwinding a sheet of web substrate 26, such as a paper web, from a supply roll, controlling the speed of the web substrate, directing the web substrate 26 into the embossing nips, and then subsequently transporting the final web product to any additional desired converting operations. Such additional converting operations may include printing, coating, perforating, folding, cutting, winding, and the like. In a preferred embodiment, the tension of the web substrate 26 can be controlled relative to a target tension.

Embossing, according to the present invention, occurs at an embossing pressure of at least about 1,000 psi and preferably between about 1,000 psi to about 10,000 psi, even more preferably between about 1,000 psi and about 5,000 psi, and more preferably from about 1,000 psi to about 3,000 psi. The desired embossing pressure is dependent upon the substrate, particularly the caliper, surface topography, and furnish of the paper web 18 to be embossed. As the surface texture topography increases, generally greater embossing pressure is required according to the present invention.

It is known that embossing pressure can be determined by the following formula:

EP=AL/(NA×PLA)

Where:

EP is the embossing pressure;

AL is the applied load;

NA is the nip area; and,

PLA is the pattern land area

The applied load is the sum of the weight of the upper embossing roll (either the pattern roll 12 or the anvil roll 14, as the case may be) and the pressure applied through the loading cylinders used to compress the pattern roll 12 and anvil roll 14 together. If the loading plane connecting the centers of the anvil roll 14 and the pattern roll 12 is not vertical, only the vertical component of the weight of the upper embossing roll (either pattern roll 12 or anvil roll 14) that is applied to the paper web 18 is considered in determining the applied load.

The nip area is the multiple of the nip width (NW) and the lesser of the width of the pattern roll 12 and anvil roll 14. The width of the paper web 18 is taken parallel to the axes of the pattern roll 12 and anvil roll 14. The nip width (NW) is taken parallel to the machine direction.

It has been surprisingly found that the nip width (NW) can be estimated by the following relationship:

$$NW = {[ \frac{5.8 \times {10}^{- 6} L T {D}_{1} {D}_{2} {P}^{1.35}}{{D}_{1} + {D}_{2}} ]}^{0.81 {{D}_{1}}^{- 0.232}}$$

Where:

D1 is the anvil roll 14 diameter in units of inches;

D2 is the pattern roll 12 diameter in units of inches;

L is the nip load in pounds per linear inch;

T is the thickness of the anvil roll 14 cover in units of inches; and,

P is the rubber hardness in units of P&J.

Referring again to FIG. 1, the exemplary embodiment of the present invention shown in plan view of the embossing apparatus 10 provides for a pattern roll 12, an anvil roll 14, and an embossing roll 16. The paper web 18 is passed between the nip formed between anvil roll 14 and pattern roll 12 and subsequently the nip formed between embossing roll 16 and pattern roll 12. In a preferred embodiment, as the paper web 18 passes between pattern roll 12 and anvil roll 14, the paper web 18 is disposed onto the protuberances 30 disposed about pattern roll 12.

In a preferred embodiment of the present invention, passing the paper web 18 between anvil roll 14 and pattern roll 12 prior to any additional steps is believed to be beneficial because the paper web is placed in a position relative to the protuberances 30 disposed upon the pattern roll in a position that effectively reduces the movement of the paper web 18 relative to the pattern roll 12. In other words, the paper web 18 is locked onto each of the protuberances 30 disposed upon pattern roll 12 due to a pressure exerted by anvil roll 14 upon pattern roll 12 and the protuberances 30 disposed thereon.

Without desiring to be bound by theory, it is believed that providing the embossing step, as that claimed by the instant invention, prior to any additional embossing or gluing steps can provide for final web product 28 having a better embossed quality and better consumer acceptance.

Referring again to FIG. 1, the paper web 18 is first passed between anvil roll 14 and pattern roll 12. At that point, the paper web 18 is effectively pressed onto the protuberances 30 disposed upon pattern roll 12. The paper web 18 then proceeds upon the surface of rotating pattern roll 12 to embossing roll 16 which can then further emboss and/or densify the paper web 18 in the region disposed between embossing roll 16 and pattern roll 12. Preferably embossing roll 16 has a hardness of greater than about 40 P&J, more preferably greater than about 70 P&J, even more preferably greater than about 90 P&J, even yet more preferably greater than about 100 P&J, yet still more preferably greater than about 120 P&J, and yet even more preferably greater than about 130 P&J. The resulting final web product 28 can be provided then with embossments having a very high level of contrast between the embossed and unembossed areas disposed upon paper web 18 as formed into final web product 28. It was surprisingly found that the arrangement of anvil roll 14, embossing roll 16, and pattern roll 12 can provide a better quality embossed final web product 28 at significantly higher line speeds than a final product produced from the systems described in the known prior art. Naturally, the production of a final web product 28 having high quality embossments produced at a very high line speed compared to those of the prior art can significantly reduce the cost associated with producing the final web product 28 as compared with those systems of the known prior art.

It was also found that the anvil roll 14 and embossing roll 16 can be produced to have a smaller diameter than the rolls used with equipment associated with the known prior art. In a preferred embodiment of the present invention, the anvil roll 14 and embossing roll 16 are provided with a diameter less than about 19 inches, preferably less than about 15 inches, yet more preferably less than about 10 inches, more preferably 5 inches to 10 inches, and most preferably about 7 inches.

In a preferred embodiment of the present invention, the protuberances 30 disposed upon the pattern roll 12 are provided with a transition region having a known radius of curvature. Such a transition region disposed upon protuberance 30 of pattern roll 12 is disposed between the distal end of the protuberance and the known sidewall of the protuberance. In a preferred embodiment of the present invention, the radius of curvature of the transition region disposed upon protuberance 30 of pattern roll 12 has a radius of greater than about 0.075 mm. In other embodiments of the present invention, the radius of curvature of the transition region disposed upon protuberance 30 of pattern roll 12 is greater than about 0.1 mm, more preferably greater than about 0.25 mm even more preferably greater than about 0.5 mm, and most preferably ranges from between about 0.075 mm and about 0.5 mm. In any regard, it is preferred that the radius of curvature disposed upon protuberance 30 of pattern roll 12 be less than about 1.8 mm. In other preferred embodiments of the present invention, the radius of curvature of protuberance 30 disposed upon pattern roll 12 is less than about 0.75 mm, more preferably ranges from between about 0.10 mm and about 0.50 mm, yet more preferably ranges from between about 0.20 mm and about 0.50 mm, and most preferably ranges from between about 0.20 mm and about 0.30 mm.

It was found that providing the protuberance 30 with a radius of curvature proximate to the distal end of the protuberance 30 disposed upon pattern roll 12 can result in a circular arc from which the radius of curvature can be determined as a traditional radius of curvature of an arc. However, it should be realized by one of skill in the art that the present invention also contemplates transition region configurations which are proximate and are ground by having the edge of the transition region of the protuberance 30 disposed upon pattern roll 12 removed by one or more straight line or irregular cut lines. In such a case, the release of curvature of the protuberance 30 can be determined by measuring the radius of curvature of a circular arc that includes a portion which approximates the curve of the transition region of the protuberance 30.

In other embodiments, at least a portion of the distal end of the protuberance 30 disposed upon pattern roll 12 (other than the transition region) can be generally non-planar (i.e., generally curved or rounded). It is in this way that the entire surface of the protuberance 30 disposed upon pattern roll 12 spanning between the sidewalls of the protuberance 30 can be non-planar. Such non-planar surfaces can take any shape, such as curved or rounded, but are not necessarily limited to smooth curves or curves as described above. This may include a number of straight line or irregular cuts to provide a non-planar surface. While not desiring to be bound by theory, it is believed that rounding the transition regions of the protuberances 30 or any portion of the distal end of the protuberances 30 can provide the final web product 28 with embossments that are more blunt with fewer rough edges, thereby preventing tearing of the web and providing the resulting embossed final web product 28 with a smoother and/or softer look and/or feel.

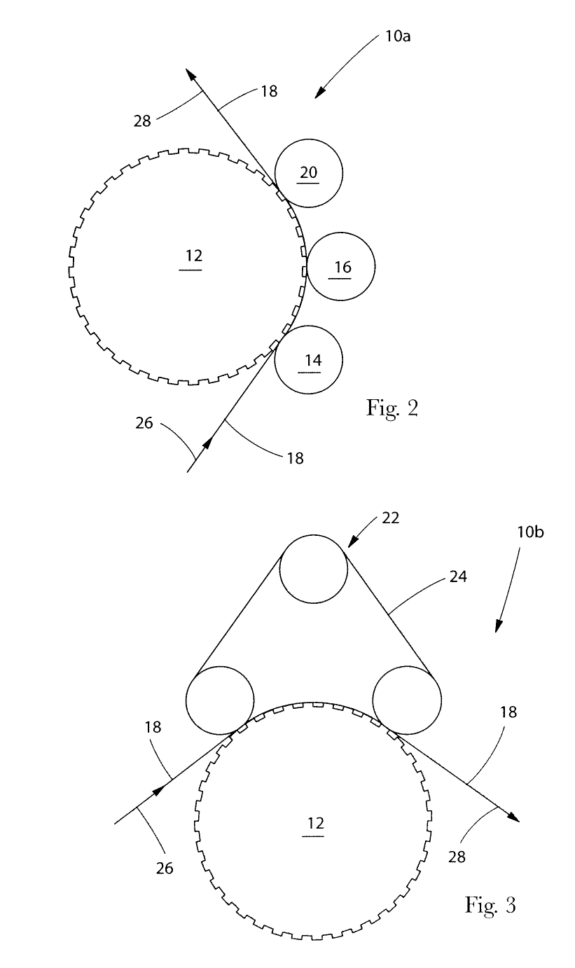

As shown in FIG. 2, exemplary apparatus 10A for embossing a paper web 18 can comprise a pattern roll 12 and any number of additional rolls as required by the process to produce final web product 28. As shown, pattern roll 12 is accompanied by anvil roll 14, embossing roll 16, and a secondary roll 20 that can provide embossments upon paper web 18 to produce final web product 28. As shown, it is preferred that anvil roll 14 have a hardness of less than about 40 P&J, more preferably less than about 30 P&J, even more preferably less than about 20 P&J, and yet more preferably less than about 10 P&J in order to lock the unformed web substrate 26 upon the protuberances 30 disposed upon pattern roll 12. As the paper web 18 progresses through the apparatus 10A, embossing roll 16 can further compress the paper web 18 upon the protuberances 30 disposed upon pattern roll 12. Similarly, secondary roll 20 can provide yet further embossment of the paper web 18 as may be required to produce final web product 28. It has been found that embossing a paper web 18 with two or more nips while the paper web 18 remains in contact with the pattern roll 12 can provide a deeper, more appealing emboss impression with less degradation to the paper web 18 strength than embossing the paper web 18 in a single nip as in the prior art.

In the alternative embodiment provided in FIG. 3, a belt mechanism 22 can be utilized to form an extended emboss nip in order to provide embossments upon paper web 18 to produce final web product 28. A belt 24 can be positioned adjacent to pattern roll 12 such that the surface of the pattern roll 12 and the surface of the belt 24 are in contact or overlap one another. The belt 24 contact or overlap with the pattern roll 12 surface may extend for a portion of the pattern roll 12 circumference to provide increased distance and time for more effective image formation in a web substrate 26 disposed between the pattern roll 12 and the belt 24. The portion of the pattern roll 12 surface contacting the belt 24 may range from 2 degrees of the pattern roll 12 circumference to as much as 200 degrees of the pattern roll 12 circumference. In a preferred embodiment, the belt 24 and the pattern roll 12 may be driven by means known in the art such that their surface speeds are essentially equal. Additionally, the belt 24 may be loaded against the pattern roll 12 by pressure regulation means known in the art, such as air cylinders, hydraulic cylinders, load sensing linear actuators, mechanical springs, and the like. Alternatively, the belt 24 may be loaded against the pattern roll 12 by displacement regulation means known in the art, such as air cylinder loading against mechanical stops, linear actuators, ball/screw mechanisms, and the like. In any regard, the belt 24 operates in cooperation with the pattern roll 12 to impart an image corresponding to the pattern on the pattern roll 12 into a web substrate 26 disposed between the pattern roll 12 and the belt 24.

As shown in FIG. 3, unformed web substrate 26 in the form of paper web 18 can be transported into contact with pattern roll 12 and belt mechanism 22 comprising belt 24. In a preferred embodiment, the belt 24 is driven at a surface speed that corresponds to the speed of the incoming paper web 18. A positioning device (not shown), such as linear actuators, servo motors, cams, links, and the like known by those of skill in the art as useful for such a result, can be provided for control of the position of the belt 24 relative to pattern roll 12. It is believed in this way the position of the belt 24 of belt mechanism 22 can provide the required contact, clearance, and/or pressure between the belt 24 and the pattern roll 12 in order to provide embossments upon paper web 18 to form final web product 28.

Optionally, belt mechanism 22 can maintain a fixed position and pattern roll 12 can be adjusted relative to the belt 24 disposed about belt mechanism 22 in order to provide the desired contact, clearance, and/or pressure between the belt 24 and pattern roll 12. In any regard, it is preferable that the belt 24 be loaded against the pattern roll 12 in order to achieve the embossment desired in a final web product 28.

The belt 24 may comprise a deformable surface such as a synthetic rubber as known in the art which, when loaded against the pattern roll 12 with a web substrate 26 disposed on the pattern roll 12 surface, deforms the sheet on and around the protuberances 30 disposed about the pattern roll 12 surface, thereby imparting the desired emboss pattern image onto the web substrate 26.

If so desired, the belt 24 disposed about belt mechanism 22 may be provided with a relieved surface or complementary to the embossing pattern disposed upon the pattern roll 12. In this embodiment, the relief portions can be provided as a pattern disposed upon or within the material comprising belt 24. Such a pattern may be disposed upon or otherwise associated with belt 24 by laser engraving, mechanical implantation, polymeric curing, or the like. In an exemplary, but non-limiting embodiment, such a pattern, relieved or otherwise, may correspond to the individual protuberances forming the embossment pattern disposed about pattern roll 12. The belt 24 pattern may be registered to the pattern roll 12 embossing pattern and driven by means known in the art to maintain the registration at all times. The belt 24 position may be controlled such that the distal ends of the belt 24 pattern elements extend into any relieved portion corresponding to any protuberances 30 disposed upon the pattern roll 12. The depth of engagement between the belt 24 pattern elements and the protuberances 30 disposed upon pattern roll 12, as well as any clearance between mating pattern elements, can be controlled to impart a desired embossing image onto the web substrate 26. The depth of engagement between the pattern roll 12 and the belt 24 may be controlled by adjusting the distance between the pattern roll 12 and the belt 24 by rotation of a ball/screw mechanism in a linear actuator, wherein the is linear actuator is coupled to the pattern roll 12 or belt 24, or by other suitable means.

In an alternative embodiment of a dual or multi-nip embossing process, the web substrate 26 may be embossed in a first emboss nip, formed by engagement between a first pattern roll 12 and a second pattern roll (not shown). The first pattern roll 12 and second pattern roll may have complementary patterns wherein the raised elements on one pattern roll may be registered and engaged with corresponding recesses in the opposing pattern roll. Passing the web substrate 26 between the first pattern roll 12 and the second pattern roll while the two pattern rolls are engaged at a first depth of engagement can provide a desired emboss impression in the web substrate 26. Engagement between the first pattern roll 12 and the second pattern roll may be controlled by adjusting the distance between the center of the first pattern roll 12 and the center of the second pattern roll by rotating a ball/screw mechanism in a linear actuator, wherein the linear actuator is coupled to one of the pattern rolls, to load the first pattern roll 12 and second pattern roll toward one another to a desired first depth of engagement. After passing through the first emboss nip formed by the first pattern roll 12 and the second pattern roll, the web substrate 26 may be further embossed in a second nip, formed by engagement between the first pattern roll 12 and a third pattern roll (not shown), wherein the third pattern roll also has a pattern complementary to the first pattern roll 12, to a desired second depth of engagement. In an alternative embodiment, three or more complementary pattern rolls may be used to emboss the web substrate 26 while the web substrate 26 is in contact with the first pattern roll 12. In yet another embodiment, the web substrate 26 may be embossed in two or more nips while the web substrate 26 remains in contact with a first pattern roll 12 wherein the first nip may comprise either an anvil roll 14 or a second pattern roll and the second nip may comprise either a second pressure roll or a third pattern roll.

As would be known to one of skill in the art, a pattern disposed upon belt 24 may be formed by first applying a synthetic rubber surface to the belt 24 and subsequently laser engraving the rubber surface to create the desired pattern. Other suitable materials may also be used for the belt 24 surface, such as metals, photopolymers, and the like. Other means known in the art may also be used to create the desired pattern upon belt 24, such as machining, photo engraving, and the like. It is believed that such an exemplary pattern associated with belt 24 may be registered with respect to any direction or directions of paper web 18, particularly the machine and cross-machine direction of paper web 18.

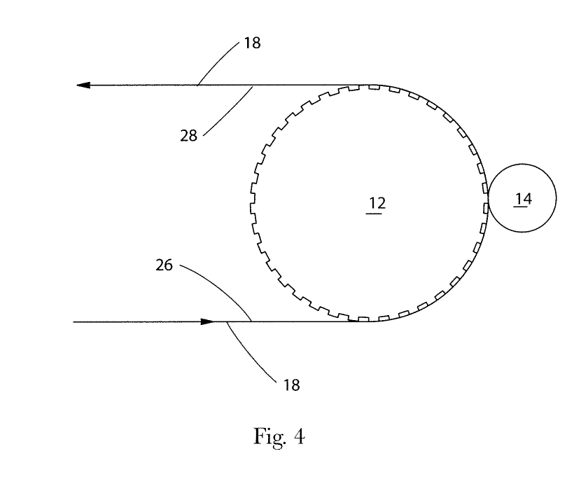

As shown in FIG. 4, an alternative apparatus 10C is shown in its simplest form. As depicted, pattern roll 12 is accompanied by a singular roll—in this case, anvil roll 14. Thus, it should be realized that as paper web 18 approaches the interstice formed between pattern roll 12 and anvil roll 14, the anvil roll 14 is provided with sufficient pressure in order to confine paper web 18 against individual protuberances 30 disposed about pattern roll 12 to provide the unformed web substrate 26 to be converted to final web product 28 having the desired embossments disposed thereupon.

### Process

The soft tissue paper of the present invention further comprises papermaking fibers of both hardwood and softwood types wherein at least about 50% of the papermaking fibers are hardwood and at least about 10% are softwood. The hardwood and softwood fibers are most preferably isolated by relegating each to separate layers wherein the tissue comprises an inner layer and at least one outer layer.

The tissue paper product of the present invention is preferably creped, i.e., produced on a papermaking machine culminating with a Yankee dryer to which a partially dried papermaking web is adhered and upon which it is dried and from which it is removed by the action of a flexible creping blade.

Creping is a means of mechanically compacting paper in the machine direction. The result is an increase in basis weight (mass per unit area) as well as dramatic changes in many physical properties, particularly when measured in the machine direction. Creping is generally accomplished with a flexible blade, a so-called doctor blade, against a Yankee dryer in an on machine operation.

A Yankee dryer is a large diameter, generally 8-20 foot drum which is designed to be pressurized with steam to provide a hot surface for completing the drying of papermaking webs at the end of the papermaking process. The paper web which is first formed on a foraminous forming carrier, such as a Fourdrinier wire, where it is freed of the copious water needed to disperse the fibrous slurry is generally transferred to a felt or fabric in a so-called press section where de-watering is continued either by mechanically compacting the paper or by some other de-watering method such as through-drying with hot air, before finally being transferred in the semi-dry condition to the surface of the Yankee for the drying to be completed.

While the characteristics of the creped paper webs, particularly when the creping process is preceded by methods of pattern densification, are preferred for practicing the present invention, un-creped tissue paper is also a satisfactory substitute and the practice of the present invention using un-creped tissue paper is specifically incorporated within the scope of the present invention. Un-creped tissue paper, a term as used herein, refers to tissue paper which is non-compressively dried, most preferably by through-drying. Resultant through air dried webs are is pattern densified such that zones of relatively high density are dispersed within a high bulk field, including pattern densified tissue wherein zones of relatively high density are continuous and the high bulk field is discrete.

To produce un-creped tissue paper webs, an embryonic web is transferred from the foraminous forming carrier upon which it is laid, to a slower moving, high fiber support transfer fabric carrier. The web is then transferred to a drying fabric upon which it is dried to a final dryness. Such webs can offer some advantages in surface smoothness compared to creped paper webs.

Tissue paper webs are generally comprised essentially of papermaking fibers. Small amounts of chemical functional agents such as wet strength or dry strength binders, retention aids, surfactants, size, chemical softeners, crepe facilitating compositions are frequently included but these are typically only used in minor amounts. The papermaking fibers most frequently used in tissue papers are virgin chemical wood pulps. Additionally, filler materials may also be incorporated into the tissue papers of the present invention.

Preferably, softening agents such as quaternary ammonium compounds can be added to the papermaking slurry. Preferred exemplary quaternary compounds have the formula:

(R₁)₄₋ₘ−N⁺−[R₂]ₘX⁻
wherein:
m is 1 to 3;
R₁ is a C₁-C₆ alkyl group, hydroxyalkyl group, hydrocarbyl or substituted hydrocarbyl group, alkoxylated group, benzyl group, or mixtures thereof;
R₂ is a C₁₄-C₂₂ alkyl group, hydroxyalkyl group, hydrocarbyl or substituted hydrocarbyl group, alkoxylated group, benzyl group, or mixtures thereof; and
X⁻is any softener-compatible anion are suitable for use in the present invention.

Preferably, each R₁ is methyl and X⁻ is chloride or methyl sulfate. Preferably, each R₂ is C₁₆-C₁₈ alkyl or alkenyl, most preferably each R₂ is straight-chain C₁₈ alkyl or alkenyl. Optionally, the R₂ substituent can be derived from vegetable oil sources.

Such structures include the well-known dialkyldimethylammonium salts (e.g. ditallowdimethylammonium chloride, ditallowdimethylammonium methyl sulfate, di(hydrogenated tallow)dimethyl ammonium chloride, etc.), in which R₁ are methyl groups, R₂ are tallow groups of varying levels of saturation, and X⁻ is chloride or methyl sulfate.

Particularly preferred variants of these softening agents are what are considered to be mono- or di-ester variations of these quaternary ammonium compounds having the formula:

(R₁)₄₋ₘ−N⁺−[(CH₂)ₙ−Y−R₃]ₘ X⁻
wherein:
Y is —O—(O)C—, or —C(O)—O—, or —NH—C(O)—, or —C(O)—NH—;
m is 1 to 3;
n is 0 to 4;
each R₁ is a C₁-C₆ alkyl group, hydroxyalkyl group, hydrocarbyl or substituted hydrocarbyl group, alkoxylated group, benzyl group, or mixtures thereof;
each R₃ is a C₁₃-C.₂₁ alkyl group, hydroxyalkyl group, hydrocarbyl or substituted hydrocarbyl group, alkoxylated group, benzyl group, or mixtures thereof; and
X⁻ is any softener-compatible anion.

Preferably, Y=—O—(O)C—, or —C(O)—O—; m=2; and n=2. Each R₁ substituent is preferably a C₁-C₃, alkyl group, with methyl being most preferred. Preferably, each R₃ is C₁₃-C₁₇ alkyl and/or alkenyl, more preferably R₃ is straight chain C₁₅-C₁₇ alkyl and/or alkenyl, C₁₅-C₁₇ alkyl, most preferably each R₃ is straight-chain C₁₇ alkyl. Optionally, the R₃ substituent can be derived from vegetable oil sources.

Specific examples of ester-functional quaternary ammonium compounds having the structures detailed above and suitable for use in the present invention may include the diester dialkyl dimethyl ammonium salts such as diester ditallow dimethyl ammonium chloride, monoester ditallow dimethyl ammonium chloride, diester ditallow dimethyl ammonium methyl sulfate, diester di(hydrogenated)tallow dimethyl ammonium methyl sulfate, diester di(hydrogenated)tallow dimethyl ammonium chloride, and mixtures thereof. Diester ditallow dimethyl ammonium chloride and diester di(hydrogenated)tallow dimethyl ammonium chloride are particularly preferred. These particular materials are available commercially from Witco Chemical Company Inc. of Dublin, Ohio under the trade name “ADOGEN SDMC”.

Typically, half of the fatty acids present in tallow are unsaturated, primarily in the form of oleic acid. Synthetic as well as natural “tallows” fall within the scope of the present invention. It is also known that depending upon the product characteristic requirements desired in the final product, the saturation level of the ditallow can be tailored from non hydrogenated (soft) to touch, partially or completely hydrogenated (hard). All of above-described levels of saturations are expressly meant to be included within the scope of the present invention.

It will be understood that substituents R₁, R₂ and R₃ may optionally be substituted with various groups such as alkoxyl, hydroxyl, or can be branched. As mentioned above, preferably is each R₁ is methyl or hydroxyethyl. Preferably, each R₂ is C₁₂-C₁₈ alkyl and/or alkenyl, most preferably each R₂ is straight-chain C₁₆-C₁₈ alkyl and/or alkenyl, most preferably each R₂ is straight-chain C₁₈ alkyl or alkenyl. Preferably R₃ is C13-C17 alkyl and/or alkenyl, most preferably R₃ is straight chain C₁₅-C₁₇ alkyl and/or alkenyl. Preferably, X⁻ is chloride or methyl sulfate. Furthermore the ester-functional quaternary ammonium compounds can optionally contain up to about 10% of the mono(long chain alkyl) derivatives, e.g., (R₂)₂ —N⁺—((CH₂)₂ OH) ((CH₂)₂ OC(O)R₃) X⁻ as minor ingredients. These minor ingredients can act as emulsifiers and can be useful in the present invention.

The use of quaternary ammonium ingredients before is most effectively accomplished if the quaternary ammonium ingredient is accompanied by an appropriate plasticizer. The plasticizer can be added during the quaternizing step in the manufacture of the quaternary ammonium ingredient or it can be added subsequent to the quaternization but prior to the application in the papermaking slurry as a chemical softening agent. The plasticizer is characterized by being substantially inert during the chemical synthesis, but acts as a viscosity reducer to aid in the synthesis and subsequent handling, i.e. application of the quaternary ammonium compound to the tissue paper product. Preferred plasticizers are comprised of a combination of a non-volatile polyhydroxy compound and a fatty acid. Preferred polyhydroxy compounds include glycerol and polyethylene glycols having a molecular weight of from about 200 to about 2000, with polyethylene glycol having a molecular weight of from about 200 to about 600 being particularly preferred. Preferred fatty acids comprise C₆-C₂₃ linear or branched and saturated or unsaturated analogs with isostearic acid being the most preferred.

While not wishing to be bound by theory, it is believed that a synergism results from the relationship of the polyhydroxy compound and the fatty acid in the mixture. While the polyhydroxy compound performs the essential function of viscosity reduction, it can be quite mobile after being laid down thus detracting from one of the objects of the present invention, i.e. that the deposited softener be. The inventors have now found that the addition of a small amount of the fatty acid is able to stem the mobility of the polyhydroxy compound and further reduce the viscosity of the mixture so as to increase the processability of compositions of a given quaternary ammonium compound fraction.

It is anticipated that wood pulp in all its varieties will normally comprise the tissue papers with utility in this invention. However, other cellulose fibrous pulps, such as cotton linters, bagasse, rayon, etc., can be used and none are disclaimed. Wood pulps useful herein include chemical pulps such as, sulfite and sulfate (sometimes called Kraft) pulps as well as mechanical pulps including for example, ground wood, ThermoMechanical Pulp (TMP) and Chemi-ThermoMechanical Pulp (CTMP). Pulps derived from both deciduous and coniferous trees can be used.

Hardwood pulps and softwood pulps, as well as combinations of the two, may be employed as papermaking fibers for the tissue paper of the present invention. The term “hardwood pulps” as used herein refers to fibrous pulp derived from the woody substance of deciduous trees (angiosperms), whereas “softwood pulps” are fibrous pulps derived from the woody substance of coniferous trees (gymnosperms). Blends of hardwood Kraft pulps, especially eucalyptus, and northern softwood Kraft (NSK) pulps are particularly suitable for making the tissue webs of the present invention. A preferred embodiment of the present invention comprises the use of layered tissue webs wherein, most preferably, hardwood pulps such as eucalyptus are used for outer layer(s) and wherein northern softwood Kraft pulps are used for the inner layer(s). Also applicable to the present invention are fibers derived from recycled paper, which may contain any or all of the above categories of fibers.

In one preferred embodiment of the present invention, which utilizes multiple papermaking furnishes, the furnish containing the papermaking fibers which will be contacted by the particulate filler is predominantly of the hardwood type, preferably of content of at least about 80% hardwood.

Other materials can be added to the aqueous papermaking furnish or the embryonic web to impart other characteristics to the product or improve the papermaking process so long as they are compatible with the chemistry of the softening agent and do not significantly and adversely affect the softness, strength, or low dusting character of the present invention. The following materials are expressly included, but their inclusion is not offered to be all-inclusive. Other materials can be included as well so long as they do not interfere or counteract the advantages of the present invention.

It is common to add a cationic charge biasing species to the papermaking process to control the zeta potential of the aqueous papermaking furnish as it is delivered to the papermaking process. These materials are used because most of the solids in nature have negative surface charges, including the surfaces of cellulosic fibers and fines and most inorganic fillers. One traditionally used cationic charge biasing species is alum. More recently in the art, charge biasing is done by use of relatively low molecular weight cationic synthetic polymers preferably having a molecular weight of no more than about 500,000 and more preferably no more than about 200,000, or even about 100,000. The charge densities of such low molecular weight cationic synthetic polymers are relatively high. These charge densities range from about 4 to about 8 equivalents of cationic nitrogen per kilogram of polymer. One example material is Cypro 514.RTM, a product of Cytec, Inc. of Stamford, Conn. The use of such materials is expressly allowed within the practice of the present invention.

The use of high surface area and high anionic charge microparticles for the purposes of improving formation, drainage, strength, and retention is taught in the art. Common materials for this purpose are silica colloid, or bentonite clay. The incorporation of such materials is expressly included within the scope of the present invention.

If permanent wet strength is desired, the group of chemicals: including polyamide-epichlorohydrin, polyacrylamides, styrene-butadiene latices; insolubilized polyvinyl alcohol; urea-formaldehyde; polyethyleneimine; chitosan polymers and mixtures thereof can be added to the papermaking furnish or to the embryonic web. Polyamide-epichlorohydrin resins are cationic wet strength resins which have been found to be of particular utility. Suitable types of such resins are described in U.S. Pat. Nos. 3,700,623 and 3,772,076. One commercial source of useful polyamide-epichlorohydrin resins is Hercules, Inc. of Wilmington, Del., which markets such resin under the mark Kymene 557H.RTM.).

Many paper products must have limited strength when wet because of the need to dispose of them through toilets into septic or sewer systems. If wet strength is imparted to these products, it is preferred to be fugitive wet strength characterized by a decay of part or all of its potency upon standing in presence of water. If fugitive wet strength is desired, the binder materials can be chosen from the group consisting of dialdehyde starch or other resins with aldehyde functionality such as Co-Bond 1000.RTM offered by National Starch and Chemical Company, Parez 750.RTM offered by Cytec of Stamford, Conn. and the resin described in U.S. Pat. No. 4,981,557.

If enhanced absorbency is needed, surfactants may be used to treat the tissue paper webs of the present invention. The level of surfactant, if used, is preferably from about 0.01% to about 2.0% by weight, based on the dry fiber weight of the tissue paper. The surfactants preferably have alkyl chains with eight or more carbon atoms. Exemplary anionic surfactants are linear alkyl sulfonates, and alkylbenzene sulfonates. Exemplary nonionic surfactants are alkylglycosides including alkylglycoside esters such as Crodesta SL-40.RTM which is available from Croda, Inc. (New York, N.Y.); alkylglycoside ethers as described in U.S. Pat. No. 4,011,389, issued to W. K. Langdon, et al. on Mar. 8, 1977; and alkylpolyethoxylated esters such as Pegosperse 200 ML available from Glyco Chemicals, Inc. (Greenwich, Conn.) and IGEPAL RC-520.RTM available from Rhone Poulenc Corporation (Cranbury, N.J.).

The present invention is further applicable to the production of multi-layered tissue paper webs. Multi-layered tissue structures and methods of forming multi-layered tissue structures are described in U.S. Pat. Nos. 3,994,771; 4,300,981; 4,166,001; and European Patent Publication No. 0 613 979 A1. The layers preferably comprise different fiber types, the fibers typically being relatively long softwood and relatively short hardwood fibers as used in multi-layered tissue paper making. Multi-layered tissue paper webs resultant from the present invention comprise at least two superposed layers, an inner layer and at least one outer layer contiguous with the inner layer. Preferably, the multi-layered tissue papers comprise three superposed layers, an inner or center layer, and two outer layers, with the inner layer located between the two outer layers. The two outer layers preferably comprise a primary filamentary constituent of relatively short paper making fibers having an average fiber length between about 0.5 and about 1.5 mm, preferably less than about 1.0 mm. These short paper making fibers typically comprise hardwood fibers, preferably hardwood Kraft fibers, and most preferably derived from eucalyptus. The inner layer preferably comprises a primary filamentary constituent of relatively long paper making fiber having an average fiber length of least about 2.0 mm. These long paper making fibers are typically softwood fibers, preferably, northern softwood Kraft fibers. Preferably, the majority of the particulate filler of the present invention is contained in at least one of the outer layers of the multi-layered tissue paper web of the present invention. More preferably, the majority of the particulate filler of the present invention is contained in both of the outer layers.

Alternatively, as shown in FIG. 3, the embossing process may comprise an extended embossing nip. This process may comprise unwinding a web substrate 26, such as a formed paper web, from a supply roll, controlling the speed of the web substrate 26, directing the web substrate 26 into an extended embossing nip, and then subsequently transporting the final web product to any additional desired converting operations. Exemplary, but non-limiting, additional converting operations may include printing, coating, perforating, folding, cutting, winding, and the like.

In a preferred embodiment, the tension of the web substrate 26 is controlled relative to a target tension. An extended embossing nip may be used to emboss the web substrate 26 while the web substrate 26 remains in contact with a pattern roll 12. Such an extended emboss nip may comprise a pattern roll 12 and a belt 24. Passing the web substrate 26 between the pattern roll 12 and the belt 24 can provide a desired emboss impression in the web substrate 26. In one embodiment, the belt 24 may be a flexible and compressible material (such as a polymer or an elastomer) that is loaded against the pattern roll 12 to form an extended embossing nip. In a preferred but non-limiting embodiment, such an extended embossing nip is greater than 5 cm in length, or greater than 10 cm in length, or greater than 20 cm in length. The loading force between the pattern roll 12 and the belt 24 may be the same throughout the extended nip, or it may be controlled to increase from the beginning of an extended nip to the end of an extended nip, or it may be controlled to decrease from the beginning of an extended nip to the end of an extended nip.

In an alternative embodiment, the loading between the pattern roll 12 and the belt 24 may be controlled to any desired level at all points within such an extended nip. The belt 24 may be loaded against the pattern roll 12 by pneumatic loading cylinders, hydraulic loading cylinders, rotation of a ball/screw mechanism in a linear actuator, or any other suitable means. The belt 24 may be slave driven by mechanical means, such as gears, that are coupled to the pattern roll 12. Alternatively, the belt 24 may be driven by a separate servo drive, or the like, that is controlled in relation to the speed of the pattern roll 12. In a preferred embodiment, the surface speed of the pattern roll 12 and the surface speed of the belt 24 are the same.

It has been found that embossing a web substrate 26 with an extended emboss nip can provide a deeper, more appealing emboss impression with less degradation to the web substrate 26 strength than embossing the web substrate 26 in a relatively short, single nip as in prior art which utilizes two rolls to form an embossing nip. In an alternative embodiment of the extended embossing nip, the belt 24 surface may comprise a pattern complementary to the pattern roll 12. The depth of engagement may be the same throughout the extended nip, or it may be controlled to increase from the beginning of the extended nip to the end of the extended nip, or it may be controlled to decrease from the beginning of the extended nip to the end of the extended nip. In an alternative embodiment, the depth of engagement between the pattern roll and the belt may be controlled to any desired level at all points within the extended nip.

### Product

The soft tissue paper of the present invention preferably has a basis weight ranging from between about 5 g/m² and about 120 g/m², more preferably between about 10 g/m² and about 75 g/m², and even more preferably between about 10 g/m² and about 50 g/m². The soft tissue paper of the present invention preferably has a density ranging from between about 0.01 g/cm³ and about 0.19 g/cm³, more preferably between about 0.02 g/m³ and about 0.1 g/cm³, and even more preferably between about 0.03 g/cm³ and about 0.08 g/cm³.

### Analytical and Testing Procedures

The following test methods are representative of the techniques utilized to determine the physical characteristics of the multi-ply tissue product associated therewith.

### 1. Sample Conditioning and Preparation

Unless otherwise indicated, samples are conditioned according to Tappi Method #T402OM-88. Paper samples are conditioned for at least 2 hours at a relative humidity of 48% to 52% and within a temperature range of 22° C. to 24° C. Sample preparation and all aspects of testing using the following methods are confined to a constant temperature and humidity room.

### 2. Basis Weight

Basis weight is measured by preparing one or more samples of a certain area (m²) and weighing the sample(s) of a fibrous structure according to the present invention and/or a paper product comprising such fibrous structure on a top loading balance with a minimum resolution of 0.01 g. The balance is protected from air drafts and other disturbances using a draft shield.

Weights are recorded when the readings on the balance become constant. The average weight (g) is calculated and the average area of the samples (m²). The basis weight (g/m²) is calculated by dividing the average weight (g) by the average area of the samples (m²).

### 3. Density

The density of multi-layered tissue paper, as that term is used herein, is the average density calculated as the basis weight of that paper divided by the caliper, with the appropriate unit conversions incorporated therein. Caliper of the multi-layered tissue paper, as used herein, is the thickness of the paper when subjected to a compressive load of 95 g/in² (14.7 g/cm²).

### 4. Reflected Light Intensity

Measure the reflected light intensity from the embossment using lighting normal to the surface and collecting the reflected light at 45 degrees from the normal.

a. Equipment

A Diagnostics Instruments Spot Insight color camera Model 320 with a Cosmicar 50 mm 1:1.8 lens, along with the SPOT v4.0.8 software was used to acquire sample images. The lens was set to an F stop of 16. The working distance to the center of the sample from the face of the lens was 29.5 cm. The field of view of the camera system was 68 mm. The sample was placed on to a 45 degree inclined glass plate that had a white heavy card stock paper glued to the surface. Lighting was provided by a Bausch and Lomb FiberLight, with a bifurcated fiber optic, adjusted to approximately 60% output. The two heads of the fiber optic were attached in parallel and aimed normal to the inclined sample stage. The working distance from the fiber optic tip to the sample was 21.5 cm. A Stouffer Cameraman's Sensitivity Guide (8 gray level steps) Part #R1215 was used to accurately adjust the light intensity (see procedure).

b. Procedure:

The white paper of the sample stage was used to obtain the flat field correction and carry out the color balance procedure as described in the SPOT software guide. The camera settings were: Exposure 80 milliseconds, Gain 4.0 and Gamma 1.0. Typical color balance values were: R=1.236, G=1.000, B=2.848. The flat field data image was stored in a separate image file. Light intensity was adjusted such that the grayscale reading from an image acquired of the Stouffer Guide read as follows for the six brightest steps (151, 112, 84, 60, 44, 32, all +/−2 gray level). The optical densities of the six Stouffer Guide steps measured with an X-Rite 418 densitometer were 0.042, 0.170, 0.313, 0.458, 0.608, and 0.755. The final image of the Stouffer target was recorded as a calibration reference. A flat field corrected image of the sample stage was also recorded for reference. Images were then captured of each sample. Images of the Stouffer target were also captured every tenth sample to confirm stability of the lighting and camera.

Image analysis was carried out using a MathWorks, Inc MatLab 2008b script (see d. Calculation Script) that first converted the color image to grayscale using mean luminance and then allowed ten embossments to be hand outlined, the outlined portion excluded the majority of the embossment transition area from the top surface to the bottom of the embossment, the embossment wall area more specifically. If the paper sample contained different types of embossments, a separate image centering on each type was acquired and quantified separately. To avoid as much of the perspective distortion as possible due to the 45 degree incline relative to the camera, only embossments near the center of the image were used for analysis. An estimate of the background brightness is obtained by drawing a large area outline of non-embossed and non-emboss transition region. The outlined areas are then used to determine the mean gray levels within the MatLab script and the output written directly to an Excel spreadsheet.

c. Results

The contrast ratio is determined by dividing the mean emboss brightness (n=10) as measured above by the background mean brightness.

d. Calculation Script

function GreyValueKnob(num_knobs)
% GrayValueKnob - This function accepts tif images from an open dialog box
% and allows the user to zoom in on a specific area, then hand identify
% areas for calculation of a mean gray value. A background area is also
% manually indicated and the values are all stored in an Excel spreadsheet.
% Usage
% GreyValueKnob(7) - use for grayscale verification
% GreyValueKnob(10) - use for knob quantitation
% Input:
% num_knobs - number of areas to manually draw. The background area is

| | |
|---|---|
| % | extra and not included in this count |

% Output:
% Excel spreadsheet with raw and calculated data
% Setup output Excel file
xls_Name=[‘EmbossLumSummary_' datestr(now, ‘yyyymmdd-HHMMSS') ‘.xls'];
d={‘Image', ‘Mean GS', ‘Std', ‘Bkgrnd GS', ‘Std', ‘Contrast', ‘Knob Lum−>'};
x_status = xlswrite(xls_Name, d,‘Data',‘A1');
num=1;
% Get tif file name, loop until cancel dialog box
while num>=1

[FileName,PathName,FilterIndex] = uigetfile(‘*.tif',‘Open towel image file');
if FilterIndex==0, return; end;
cd (PathName);
% read file and convert to grayscale
[t_color] = imread (FileName);
t_gray = rgb2gray(t_color);
% display image and pause to zoom
imagesc(t_gray); colorbar; colormap(‘jet');
title(‘Towel grey image');
xlabel(‘Zoom area of interest, then hit Return');
zoom on;
beep; pause;
zoom off;
% Get polyroi for each knob
for knob = 1:num_knobs

xlabel([‘Draw emboss ' num2str(knob)]);
bw = roipoly;
gs(knob)=mean(t_gray(find(bw>0)));
% find the perimeter points
bwe=imerode(bw,ones(5,5));
bwp=bw-bwe;
per_pts=find(bwp>0);
% burn perimeter into image
t_gray(per_pts)=0.95*min(t_gray(:));

end
% Get background area
xlabel(‘Draw background');
bw = roipoly;
% calc background values
bgrnd = mean(t_gray(find(bw>0)));
stdbg = std(double(t_gray(find(bw>0))));
% calcualte contrast value
tcontrast = mean(gs)/bgrnd;
% find the background perimeter points
bwe=imerode(bw,ones(5,5));
bwp=bw-bwe;
per_pts=find(bwp>0);
% burn background perimeter into image darker than knobs
t_gray(per_pts)=0.75*min(t_gray(:));
imagesc(t_gray);
xlabel ([‘Segmented image: ' FileName]);
colormap(gray(256));
beep;
pause; % wait for manual figure save if needed...
beep;
% format output results for Excel
d={FileName, mean(gs), std(gs), bgrnd, stdbg, tcontrast};
for j=1:num_knobs

d(j+6)={gs(j)};

end
% Write data to Excel in next row
x_status = xlswrite(xls_Name, d,‘Data',[‘A' num2str(num+1)]);
num=num+1;
display(‘Done...next image');

end
return

### 5. Embossment Structure Measurement

The geometric characteristics of the embossment structure of the present invention are measured using an Optical 3D Measuring System MikroCAD compact for paper measurement instrument (the “GFM MikroCAD optical profiler instrument”) and ODSCAD Version 4.14 software available from GFMesstechnik GmbH, Warthestraβe E21, D14513 Teltow, Berlin, Germany. The GFM MikroCAD optical profiler instrument includes a compact optical measuring sensor based on digital micro-mirror projection, consisting of the following components:

A) A DMD projector with 1024×768 direct digital controlled micro-mirrors.

B) CCD camera with high resolution (1280×1024 pixels).

C) Projection optics adapted to a measuring area of at least 160×120 mm.

D) Recording optics adapted to a measuring area of at least 160×120 mm;

E) Schott KL1500 LCD cold light source.

F) A table stand consisting of a motorized telescoping mounting pillar and a hard stone plate;

G) Measuring, control and evaluation computer.

H) Measuring, control and evaluation software ODSCAD 4.14.

I) Adjusting probes for lateral (XY) and vertical (Z) calibration.

The GFM MikroCAD optical profiler system measures the height of a sample using the digital micro-mirror pattern projection technique. The result of the analysis is a map of surface height (Z) versus XY displacement. The system should provide a field of view of 160×120 mm with an XY resolution of 21 μm. The height resolution is set to between 0.10 μm and 1.00μm. The height range is 64,000 times the resolution. To measure a fibrous structure sample, the following steps are utilized:

1. Turn on the cold-light source. The settings on the cold-light source are set to provide a reading of at least 2,800 k on the display.

2. Turn on the computer, monitor, and printer, and open the software.

3. Verify calibration accuracy by following the manufacturers instructions.

4. Select “Start Measurement” icon from the ODSCAD task bar and then click the “Live Image” button.

5. Obtain a fibrous structure sample that is larger than the equipment field of view and conditioned at a temperature of 73° F.±2° F. (about 23° C.±1° C.) and a relative humidity of 50%±2% for 2 hours. Place the sample under the projection head. Position the projection head to be normal to the sample surface.

6. Adjust the distance between the sample and the projection head for best focus in the following manner. Turn on the “Show Cross” button. A blue cross should appear on the screen. Click the “Pattern” button repeatedly to project one of the several focusing patterns to aid in achieving the best focus. Select a pattern with a cross hair such as the one with the square. Adjust the focus control until the cross hair is aligned with the blue “cross” on the screen.

7. Adjust image brightness by increasing or decreasing the intensity of the cold light source or by altering the camera gains setting on the screen. When the illumination is optimum, the red circle at the bottom of the screen labeled “I.O” will turn green.

8. Select “Standard” measurement type.

9. Click on the “Measure” button. The sample should remain stationary during the data acquisition. 10. To move the data into the analysis portion of the software, click on the clipboard/man icon.

11. Click on the icon “Draw Cutting Lines.” On the captured image, “draw” a cutting line that extends from the center of a negative embossment through the centers of at least six negative embossments, ending on the center of a final negative embossment. Click on the icon “Show Sectional Line Diagram.” Move the cross-hairs to a representative low point on one of the left hand negative embossments and click the mouse. Then move the cross-hairs to a representative low point on one of the right hand negative embossments and click the mouse. Click on the “Align” button by marked point's icon. The Sectional Line Diagram is now adjusted to the zero reference line.

12. Measurement of Emboss Height, h. Using the Sectional Line Diagram described in step 11, click the mouse on a representative low point of a negative emboss, followed by clicking the mouse on a representative point on the nearby upper surface of the sample. Click the “Vertical” distance icon. Record the distance measurement. Repeat the previous steps until the depth of six negative embossments have been measured. Take the average of all recorded numbers and report in mm, or μm, as desired. This number is the embossment height.

13. Measurement of Wall Angle, a. Using the Sectional Line Diagram of step 11, select with the mouse two points on the wall of a negative embossment that represent respectively 33% and 66% of the depth measured in step 12. Click the “Angle” icon. The ODSCAD software calculates the angle between a) the straight line connecting the two selected points and b) the zero reference line described in step 11. This angle is the wall angle. Repeat these steps for the six negative embossments measured in step 12.

14. Measurement of Emboss Area, A. Using the Sectional Line Diagram of step 11, select with the mouse two points on each wall of a negative embossment that represents 50% of the depth measured in step 12. Click the “horizontal distance” icon. The horizontal distance is the diameter of an equivalent circle. The area of that circle is calculated using the formula Area=2*pi*(d/2)̂2 and is recorded as the Equivalent Emboss Area. If the embossment shape is elliptical or irregular, more sectional lines are needed, cutting through the embossment from different directions, to calculate the equivalent area. Repeat these steps for the six negative embossments measured in step 12.

### EXAMPLES

### A. Example 1

One fibrous structure useful in achieving the embossed multi-ply paper product of the present invention is the through-air-dried (TAD), differential density structure described in U.S. Pat. No. 4,528,239. Such a product may be formed by the following process.

A Fourdrinier, through-air-dried papermaking machine is used. A slurry of papermaking fibers is pumped to the headbox at a consistency of about 0.15%. The slurry consists of about 70% Northern Softwood Kraft fibers, about 30% unrefined Eucalyptus fibers, a cationic polyamine-epichlorohydrin wet burst strength resin at a concentration of about 25 lbs per ton of dry fiber, and carboxymethyl cellulose at a concentration of about 5 lbs per ton of dry fiber, as well as DTDMAMS at a concentration of about 6 lbs per ton of dry fiber.

Dewatering occurs through the Fourdrinier wire and is assisted by vacuum boxes. The embryonic wet web is transferred from the Fourdrinier wire at a fiber consistency of about 20% at the point of transfer, to a TAD carrier fabric. The wire speed is about 620 feet per minute. The carrier fabric speed is about 600 feet per minute. Since the wire speed is faster than the carrier fabric, wet shortening of the web occurs at the transfer point. Thus, the wet web foreshortening is about 3%.

The consistency of the web is about 60% after the action of the TAD dryers operating about a 400° F., before transfer onto the Yankee dryer. An aqueous solution of creping adhesive is applied to the Yankee surface by spray applicators before the location of the sheet transfer. The fiber consistency is increased to an estimated 95.5% before creping the web with a doctor blade. The doctor blade has a bevel angle of about 25 degrees and is positioned with respect to the Yankee dryer to provide an impact angle of about 81 degrees. The Yankee dryer is operated at about 360° F., and Yankee hoods are operated at about 350° F.

The dry, creped paper web is passed between two calendar rolls and rolled on a reel operated at 560 feet per minute so that there is about 7% foreshortening of the web by crepe.

The paper web described above is then subjected to a knob-to-rubber impression embossing apparatus and process as follows: A 14″ diameter embossing roll is engraved with a nonrandom pattern of embossing protrusions. The embossing protrusions have a wall angle of 102.5° and a round or oval surface with a major/minor axis of 0.1″, and a height of 0.065″. There are 30 embossing protrusions per square inch. The paper web passes a 0.63″ nip formed between the embossing roll and a first pressure roll having a hardness of about 17 P&J and a diameter of about 7 inches that is juxtaposed in an axially parallel arrangement with the embossing roll. The resultant paper product is passed through a 1.50″ nip formed between the embossing roll and a is second pressure roll having a hardness of about 125 P&J and a diameter of about 7 inches that is juxtaposed in an axially parallel arrangement with the embossing roll. The above converting operations are carried out at a constant sheet velocity of about 1000 fpm.

Surprisingly, the resultant embossed multi-ply paper product has a more pronounced emboss pattern than products of the prior art. In addition, the resultant embossed product exhibits emboss registration which is greatly improved over that produced by prior art embossing processes.

### B. Example 2

A product produced as detailed in Example #1 supra is ply bonded to a second product produced as detailed in Example #1 supra. The resulting 2-ply substrate is processed as detailed infra.

The paper web described above is then subjected to a knob-to-rubber impression embossing apparatus and process as follows: A 14 inch diameter embossing roll is engraved with a nonrandom pattern of embossing protrusions. The embossing protrusions have a wall angle of 102.5°, round or oval surface with a major/minor axis of 0.1″, and a height of 0.130″. There are 18 embossing protrusions per square inch.

The paper web passes a 0.63″ nip formed between the embossing roll and a first pressure roll having a hardness of about 17 P&J and a diameter of about 7 inches that is juxtaposed in an axially parallel arrangement with the embossing roll. After undergoing an initial embossing transformation, the paper web passes a second 1.5″ nip formed between the embossing roll and pressure roll having a hardness of 125 P&J and a diameter of about 7 inches that is juxtaposed in an axially parallel arrangement with the embossing roll. After undergoing the second embossing transformation, the paper web passes a an adhesive application roll that is juxtaposed in an axially parallel arrangement with the embossing roll such that the adhesive application roll contacts the distal end of the embossing protrusions, and therefore adhesive is only applied to the embossed areas of the paper web. Once adhesive has been applied to the embossed areas, the paper web then passes between a nip formed between the embossing roll and a marrying roll, which marries the paper web to a different paper web, which is also as described above, and is also passed through the nip formed between the embossing roll and the marrying roll. The above converting operations are carried out at a constant sheet velocity of about 1000 fpm.

Again surprisingly, the resultant embossed multi-ply paper product has a more pronounced emboss pattern than products of the prior art. In addition, the resultant embossed multi-ply paper product exhibits registration which is greatly improved over that produced by prior art embossing processes.

Both products produced above are tested according to the intensity method detailed herein. The resulting intensity data is provided in Table 1.

TABLE 1
Product intensity measurement data

| Sample | Contrast |
|---|---|
| Example 1 (1-ply) | 1.31 |
| Example 2 (2-ply) | 1.24 |
| Vanity Fair Napkins (1-ply) | 1.22 |
| Brawny (2-ply) | 1.20 |
| Famliy Dollar towel (2-ply) | 1.18 |
| Publix towel (2-ply) | 1.16 |
| Quilted Nothern Ultra Plush tissue (3-ply) | 1.15 |
| 1st Quality towel (2-ply) | 1.14 |
| Kroger Nice & Strong napkin (1-ply) | 1.14 |
| Shoppers Value towel (2-ply) | 1.14 |
| Bounty towel (2-ply) | 1.14 |
| Angel Soft tissue (2-ply) | 1.14 |
| Thrifty Made towel (2-ply) | 1.13 |
| Dixie napkins (1-ply) | 1.13 |
| Target Premium towel (2-ply) | 1.12 |
| Charmin Ultra Strong (2-ply) | 1.12 |
| Kroger Nice & Soft tissue (2-ply) | 1.10 |
| Mardi Gras napkins (1-ply) | 1.03 |
| Kroger Nice & Elegant napkins (2-ply) | 1.03 |

A preferred embodiment of the present invention provides a single ply paper product having a contrast ratio greater than about 1.25 as measured according to the Reflected Light Intensity test method, more preferably greater than about 1.30, even more preferably ranging from about 1.25 to about 1.5, yet more preferably ranging from about 1.25 to about 1.35, and most preferably ranging from about 1.30 to about 1.35.

A preferred embodiment of the present invention provides a two-ply paper product having a contrast ratio greater than about 1.22 as measured according to the Reflected Light Intensity test method, more preferably greater than about 1.25, even more preferably greater than about 1.30, yet more preferably ranging from about 1.25 to about 1.50, and most preferably ranging from about 1.25 to about 1.35.

The embossments of the product of the present invention have an embossment height, h, of greater than about 800 microns, preferably greater than about 1000 microns, and more preferably greater than about 1100 microns. The embossment height is measured using the Embossment Structure Measurement Method described in the test methods herein. The embossment height, h, is a measure from the top of the unembossed structure to the bottom of the embossment as described in the test method.

While particular embodiments of the present invention have been illustrated and described herein, it would be obvious to those skilled in the art that various other changes and modifications can be made without departing from the spirit and scope of the invention. It is therefore intended to cover in the appended claims all such changes and modifications that are within the scope of this invention.

The dimensions and values disclosed herein are not to be understood as being strictly limited to the exact numerical values recited. Instead, unless otherwise specified, each such dimension or value is intended to mean both the recited dimension or value and a functionally equivalent range surrounding that dimension or value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

What is claimed is:

1. A process for embossing a web substrate, the process comprising the steps of:
disposing said web substrate in a circumferentially elongate nip formed between a pattern roll having a circumference and an embossing pattern disposed upon a surface thereof and a continuous belt disposed about at least a portion of said circumference of said pattern roll;
providing said continuous belt with a surface speed corresponding to a speed of said web substrate; and,
juxtaposing said embossing pattern upon said web substrate while said web substrate is disposed within said elongate nip.

2. The process of claim 1 further comprising the step of providing said continuous belt with a deformable surface.

3. The process of claim 2 further comprising the step of transporting said web substrate into contacting engagement with said surface of said pattern roll.

4. The process of claim 1 wherein said step of adjusting said continuous belt relative to said surface of said pattern roll further comprises the step of adjusting said continuous belt relative to said surface of said pattern roll with at least a first positioning device.

5. The process of claim 4 wherein said step of adjusting said continuous belt relative to said surface of said pattern roll further comprises the step of adjusting said continuous belt relative to said surface of said pattern roll with a second positioning device.

6. The process of claim 1 further comprising the step of providing said continuous belt with a relieved surface corresponding to said embossing pattern.

7. The process of claim 1 further comprising the step of disposing said continuous belt about said circumference of said pattern roll from about 2 degrees of said circumference of said pattern roll to about 200 degrees of said circumference of said pattern roll.

8. The process of claim 1 further comprising the step of providing said web substrate as at least one ply.

9. The process of claim 1 further comprising the step of adjusting said continuous belt relative to said surface of said pattern roll to provide a compressive force on said surface of said pattern roll.

10. A process for embossing a web substrate, the process comprising the steps of:
disposing said web substrate in a circumferentially elongate nip formed between a pattern roll having a circumference and an embossing pattern disposed upon a surface thereof and a continuous belt disposed about at least a portion of said circumference of said pattern roll;
providing said continuous belt with a surface speed corresponding to a speed of said web substrate;
adjusting said surface of said pattern roll relative to said continuous belt to provide a compressive force on said surface of said pattern roll; and,
juxtaposing said embossing pattern upon said web substrate while said web substrate is disposed within said elongate nip.

11. The process of claim 10 further comprising the step of providing said continuous belt with a deformable surface.

12. The process of claim 11 further comprising the step of transporting said web substrate into contacting engagement with said surface of said pattern roll.

13. The process of claim 10 wherein said step of adjusting said continuous belt relative to said surface of said pattern roll further comprises the step of adjusting said continuous belt relative to said surface of said pattern roll with at least a first positioning device.

14. The process of claim 13 wherein said step of adjusting said continuous belt relative to said surface of said pattern roll further comprises the step of adjusting said continuous belt relative to said surface of said pattern roll with a second positioning device.

15. The process of claim 10 further comprising the step of providing said continuous belt with a relieved surface corresponding to said embossing pattern.

16. The process of claim 10 further comprising the step of disposing said continuous belt about said circumference of said pattern roll from about 2 degrees of said circumference of said pattern roll to about 200 degrees of said circumference of said pattern roll.

17. The process of claim 10 further comprising the step of providing said web substrate as at least one ply.

18. The process of claim 17 further comprising the step of providing said web substrate as at least two plies.

19. A process for embossing a web substrate, the process comprising the steps of:
disposing said web substrate in a circumferentially elongate nip formed between a pattern roll having a circumference and an embossing pattern disposed upon a surface thereof and a continuous belt disposed about at least a portion of said circumference of said pattern roll;
providing said continuous belt with a surface speed corresponding to a speed of said web substrate;
adjusting said continuous belt relative to said surface of said pattern roll to provide a desired distance between said continuous belt and said surface of said pattern roll; and,
juxtaposing said embossing pattern upon said web substrate while said web substrate is disposed within said elongate nip.

20. The process of claim 19 further comprising the step of adjusting said continuous belt relative to said surface of said pattern roll to provide a desired compressive force upon said surface of said pattern roll.
